(19) United States
(12) Patent Application Publication
(10) Pub. No.: US 2015/0015815 A1
(43) Pub. Date: Jan. 15, 2015

(54) STEREOSCOPIC IMAGE DISPLAY DEVICE AND STEREOSCOPIC IMAGE DISPLAY SYSTEM

(71) Applicant: FUJIFILM Corporation, Tokyo (JP)

(72) Inventor: Naoyoshi YAMADA, Kanagawa (JP)

(73) Assignee: FUJIFILM CORPORATION, Tokyo (JP)

(21) Appl. No.: 14/503,984

(22) Filed: Oct. 1, 2014

Related U.S. Application Data
(63) Continuation of application No. PCT/JP2013/060041, filed on Apr. 2, 2013.

(30) Foreign Application Priority Data
Apr. 6, 2012 (JP) 2012-087061

(51) Int. Cl. G02B 27/26; G02F 1/1335

(52) U.S. Cl. CPC G02B 27/26; G02F 1/133512
USPC 349/15; 359/465

(57) ABSTRACT

A stereo picture display apparatus with decreased cross talk without a decrease in an aperture ratio, includes a picture displaying panel and a patterned retardation plate disposed on a viewer side of a picture displaying panel which includes left eye pixels and right eye pixels which are alternatively disposed at an integer of 2 or more, and black matrices; the patterned retardation plate includes a support and a patterned optically anisotropic layer thereon, having a first and second retardation region, and a boundary, the first and second retardation regions being alternately disposed at a predetermined pitch width in stripe pattern. The first and second retardation regions are different in at least one of an in-plane slow axis direction and a retardation from each other. The black matrices disposed at a position corresponding to the boundary have a larger width than a width of the black matrices not disposed thereat.

### CROSS-REFERENCE TO RELATED APPLICATIONS

This application is a Continuation of PCT International Application No. PCT/JP2013/060041 filed on Apr. 2, 2013, which claims priority under 35 U.S.C §119(a) to Japanese Patent Application No. 2012-087061, filed on Apr. 6, 2012. The above application is hereby expressly incorporated by reference, in its entirety, into the present application.

### TECHNICAL FIELD

The present invention relates to a stereo picture display apparatus and a stereo display system.

### BACKGROUND ART

A stereo (3-dimensional) picture display apparatus displaying a stereo picture involves an optical member for causing a right eye picture and a left eye picture to be, for example, circularly polarized in the opposite directions to each other. For example, such an optical member includes a patterned optically anisotropic element having regions which have mutually different slow axes or retardations and regularly disposed in the plane. A proposed support for the patterned optically anisotropic element is a so-called film-patterned retarder (FPR).

In a stereo picture display apparatus including a member having a patterned optically anisotropic element, for example, pixels for right and left eye pictures disposed in a displaying panel, such as a liquid crystal panel, is laminated on the respective retardation regions for right and left eye pictures in a patterned optically anisotropic layer. Such a stereo picture display apparatus usually includes a patterned optically anisotropic layer having a stripe pattern. This patterned optically anisotropic layer is usually bonded on the displaying panel such that the direction of a periodic pattern (the direction in which different stripe retardation regions are alternated) is identical to the vertical direction of the display surface. FIG. 7 schematically illustrates example pixels for right and left eye pictures of a displaying panel disposed corresponding to right and left eye picture retardation regions of a patterned optically anisotropic layer. As indicated by an arrow A in FIG. 7, in a view in the direction of a substantially normal line of the display surface, light passing through the right eye picture pixel (R) in the displaying panel passes through the right eye picture retardation region (R) in the patterned optically anisotropic layer. This case causes no cross talk. As indicated by an arrow B in FIG. 7, in a view in a direction vertically shifted from the normal line direction of the display surface, light passing through the right eye picture pixel (R) in the displaying panel (for example, in a liquid crystal cell) passes through the left eye picture retardation region (L) in the patterned optically anisotropic layer. This case causes cross talk. Unfortunately, the viewing angle of a 3-dimensional picture decreases in the vertical direction of the display surface.

In addition, a decrease in the width of a pixel due to recent trends toward high resolution is anxious about a further increase in vertical cross talk.

Several techniques have been proposed to solve the above problems. In an example technique illustrated in FIG. 8, a thicker black matrix of a color filter disposed in a liquid crystal cell increase the vertical viewing angle to decrease cross talk (for example, PTLs 1 and 2). In another example technique illustrated in FIG. 9, a decrease in the thickness of a material, such as glass, between a color filter disposed in a liquid crystal cell and an FPR decreases the distance between the color filter and the FPR to increase the vertical viewing angle and to decrease cross talk (for example, PTL 3). These techniques decrease cross talk in some degree in comparison with that in FIG. 7, but do not provide a sufficient effect.

The techniques disclosed in PTLs 1 to 3 can decrease cross talk, but a thicker black matrix of the color filter decreases the aperture ratio. As a result, a picture to be displayed with high luminance requires a light source with higher luminance. This configuration may increase not only a production cost due to the used light source but also electric power consumption during operations. Moreover, the material, such as glass, having a smaller film thickness problematically increases difficulty of handling.

### CITATION LIST

### Patent Literature

[PTL 1] Japanese Unexamined Patent Application Publication No. 2011-164563
[PTL 2] Japanese Unexamined Patent Application Publication No. 2011-34045
[PTL 3] Japanese Unexamined Patent Application Publication No. 10-268233

### SUMMARY OF INVENTION

### Solution to Problem

It is an object of the present invention to solve the above problems, more specifically, to provide a stereo picture display apparatus with decreased cross talk without a decrease in an aperture ratio, and a stereo picture display system.

### Solution to Problem

The above problems are solved by means [1] and are preferably solved by means [2] to [11], as described below.

[1] A stereo picture display apparatus comprising a picture displaying panel and a patterned retardation plate disposed on a viewer side of the picture displaying panel, wherein

the picture displaying panel comprises left eye pixels corresponding to a left eye picture, and right eye pixels corresponding to a right eye picture, and black matrices;

the left eye pixels and the right eye pixels alternatively being disposed at intervals of n pixels where n is an integer of 2 or more,

the black matrices being disposed between each of the pixels,

the patterned retardation plate comprises a support, and a patterned optically anisotropic layer disposed on the support;

the optically anisotropic layer having first retardation regions, second retardation regions, and boundaries, the first and second retardation regions being alternately disposed at a predetermined pitch width in stripe pattern,

the first and second retardation regions being different in at least one of an in-plane slow axis direction and a retardation from each other,

the boundary being disposed between the first and second retardation regions;

the first retardation region is disposed so as to correspond to one of the right eye pixels and left eye pixels while the second retardation region is disposed so as to correspond to the other pixies;

the pitch width of the first and second retardation region is n times the width of the pixel in the picture displaying panel; and

the black matrices disposed at a position corresponding to the boundary have a larger width than a width of the black matrices not disposed at a position corresponding to the boundary.

[2] The stereo picture display apparatus according to [1], which satisfies a ≦0.25×r, where a is a width of the black matrix at the position not corresponding to the boundary, and r is a width of the right or left eye pixel.
[3] The stereo picture display apparatus according to [1] or [2], which satisfies b≧0.10×d, where b is a width of the black matrix at the position corresponding to the boundary, and d is a distance between the pixel and the first or second retardation region.
[4] The stereo picture display apparatus according to any one of [1] to [3], which satisfies b≦r, where b is a width of the black matrix at the position corresponding to the boundary, and r is a width of the right or left eye pixel.
[5] The stereo picture display apparatus according to any one of [1] to [4], wherein the stereo picture display apparatus has a vertical resolution of 720 or more pixels.
[6] The stereo picture display apparatus according to any one of [1] to [5], which satisfies 1.5≦b/a≦10 where a is a width of the black matrix at the position not corresponding to the boundary, and b is a width of the black matrix at the position corresponding to the boundary.
[7] The stereo picture display apparatus according to any one of [1] to [6], wherein the first and second retardation regions have mutually orthogonal in-plane slow axes and have an in-plane retardation of λ/4.
[8] The stereo picture display apparatus according to any one of [1] to [7], wherein n is 2.
[9] The stereo picture display apparatus according to any one of [1] to [8], wherein the support is a polymer film.
[10] The stereo picture display apparatus according to anyone of [1] to [9], wherein the picture displaying panel is a liquid crystal displaying panel.
[11] A stereo picture display system allowing a viewer to view a stereo picture on the stereo picture display apparatus according to any one of [1] to [10] through circularly polarizing plate glasses.

### Advantageous Effects of Invention

The present invention can provide a stereo picture display apparatus with decreased cross talk without a decrease in an aperture ratio, and a stereo picture display system.

### BRIEF DESCRIPTION OF DRAWINGS

FIG. 1 is a schematic sectional view of an exemplary stereo picture display apparatus of the present invention.

FIG. 2 is a schematic top view of an exemplary patterned optically anisotropic layer.

FIG. 3 is a vertical schematic sectional view of an exemplary relationship between a patterned retardation plate and pixels of a picture displaying panel.

FIG. 4 is a vertical schematic sectional view of another exemplary relationship between a patterned retardation plate and pixels of a picture displaying panel.

FIG. 5 is an enlarged view of the pixels in the picture displaying panel in FIG. 3.

FIG. 6 is a schematic diagram of an exemplary relationship between a polarizing film and the optically anisotropic layer.

FIG. 7 schematically illustrates a typical traditional configuration of pixels for right and left eye pictures of a picture displaying panel disposed corresponding to right and left eye picture retardation regions of a patterned optically anisotropic layer.

FIG. 8 schematically illustrates a typical known configuration involving pixels for right and left eye pictures with a thicker black matrix disposed corresponding to right and left eye picture retardation regions of a patterned optically anisotropic layer.

FIG. 9 schematically illustrates a typical traditional configuration of a decreased thickness of a glass plate disposed between pixels for right and left eye pictures and right and left eye picture retardation regions of a patterned optically anisotropic layer in a picture displaying panel.

### DESCRIPTION OF EMBODIMENTS

The contents of the invention are described in detail hereinunder. In this description, the numerical range expressed by the wording “a number to another number” means the range that falls between the former number indicating the lowermost limit of the range and the latter number indicating the uppermost limit thereof. In addition, throughout the specification, numerical ranges and numerical values should be construed as ones including errors generally acceptable in the field of the invention.

As used herein, symbol Re(λ) refers to the retardation in a plane at a wavelength λ (nm), and symbol Rth(λ) refers to the retardation across the thickness at a wavelength λ (nm). Re(λ) is measured by irradiating a film with light having a wavelength λ (nm) in the normal direction with a KOBRA 21ADH or KOBRA WR birefringence analyzer (from Oji Scientific Instruments). The measurement wavelength λ (nm) may be selected by manually replacing a wavelength selective filter or converting the measurements, for example, with software. If the film for measurement has a uniaxial or biaxial optical indicatrix, Rth(λ) is calculated through the following procedure.] When a film to be analyzed is expressed by a monoaxial or biaxial index ellipsoid, Rth(λ) of the film is calculated as follows. Rth(λ) is calculated by KOBRA 21ADH or WR on the basis of the six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane), a value of hypothetical mean refractive index, and a value entered as a thickness value of the film.

In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR.

Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to formulae (A) and (B);

$$Re ( θ ) = [ nx - \frac{( ny \times nz )}{( \sqrt{{( ny sin ( {sin}^{- 1} ( \frac{sin ( - θ )}{nx} ) ) )}^{2} + {( nz cos ( {sin}^{- 1} ( \frac{sin ( - θ )}{nx} ) ) )}^{2}} )} ] \times \frac{d}{cos ( {sin}^{- 1} ( \frac{sin ( - θ )}{nx} ) )} \qquad formula ( A )$$

Re(θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the film.

In the formula, nx represents a refractive index in the in-plane slow axis direction; ny represents a refractive index in the in-plane direction perpendicular to nx; and nz represents a refractive index in the direction perpendicular to nx and ny. And “d” is a thickness of the film.

Rth={(nx+ny)/2−nz}×d (B):

When the film to be analyzed is not expressed by a monoaxial or biaxial index ellipsoid, or that is, when the film does not have an optical axis, then Rth(λ) of the film may be calculated as follows:

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth(λ) of the film may be calculated by KOBRA 21ADH or WR.

In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some main retardation films are listed below:

cellulose acylate (1.48), cycloolefin polymer (1.52), polycarbonate (1.59), polymethylmethacrylate (1.49) and polystyrene (1.59).

The instrument KOBRA-21ADH or KOBRA-WR calculates nx, ny, and nz, through input of the assumed average refractive index and the film thickness, and then calculates Nz=(nx−nz)/(nx−ny) on the basis of the calculated nx, ny, and nz.

Re and Rth are measurements at a wavelength of 550 nm, which falls within the visible range, unless otherwise stated.

Throughout the specification, “visible light” refers to the range of 380 to 780 nm. The wavelength for the measurement is 550 nm, unless otherwise stated.

Throughout the specification, an angle (for example, “90°”) and relational expressions thereto (for example, “orthogonal”, “parallel”, “crossing at 45°”) should include an error range acceptable in the technical field including the present invention. For example, this refers to a range within a strict angle ±less than 10°, and the error from the strict angle is preferably at most 5°, more preferably at most 3°.

The stereo picture display apparatus according to the present invention comprises a picture displaying panel and a patterned retardation plate disposed on a viewer side of the picture displaying panel, wherein

the picture displaying panel comprises left eye pixels corresponding to a left eye picture, and right eye pixels corresponding to a right eye picture, and black matrices;

the left eye pixels and the right eye pixels alternatively being disposed at intervals of n pixels where n is an integer of 2 or more,

the black matrices being disposed between each of the pixels,

the patterned retardation plate comprises a support, and a patterned optically anisotropic layer disposed on the support;

the optically anisotropic layer having first retardation regions, second retardation regions, and boundaries, the first and second retardation regions being alternately disposed at a predetermined pitch width in stripe pattern,

the first and second retardation regions being different in at least one of an in-plane slow axis direction and a retardation from each other,

the boundary being disposed between the first and second retardation regions;

the first retardation region is disposed so as to correspond to one of the right eye pixels and left eye pixels while the second retardation region is disposed so as to correspond to the other pixies;

the pitch width of the first and second retardation region is n times the width of the pixel in the picture displaying panel; and

the black matrices disposed at a position corresponding to the boundary have a larger width than a width of the black matrices not disposed at a position corresponding to the boundary.

In the picture displaying panel of the present invention, the n left eye pixels and the n right eye pixels are alternately disposed, and the black matrices disposed between each pixels disposed at a position corresponding to the boundary have a larger width at a position corresponding to the boundary have a larger width than a width of the black matrices not disposed at a position corresponding to the boundary. In the patterned retardation plate, the pitch width of each of the first and second retardation regions is n times the width of the pixel in the picture displaying panel.

In the present invention, the black matrices disposed at the boundary have a larger width at a position corresponding to the boundary than a width at a position not corresponding to the boundary. This configuration can enlarge the vertical cross talk viewing angle. In addition, the pitch width of the first and second retardation regions is n times the width of the pixel in the picture displaying panel, and the left eye pixels and the right eye pixels are alternatively disposed at intervals of an integer of 2 or more. This configuration can enlarge a vertical cross talk viewing angle regardless of a decrease in the width of a pixel due to recent trends toward high resolution and can solve the problematic decrease in an aperture ratio in traditional techniques.

Several embodiments of the present invention will be described with reference to the accompanying drawings. The relative thickness between individual layers in the drawings does not reflect the actual relative relationship. In the drawings, the same components are designated with the same reference numerals without redundant descriptions. The drawings illustrate the configuration involving a patterned retardation plate with a support composed of a polymer film. The support, however, may be a glass plate or a plastic substrate without flexibility, for example.

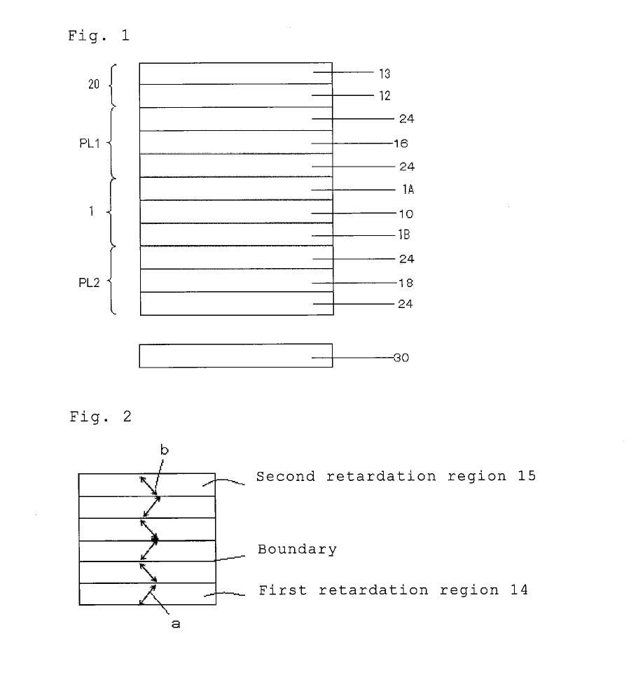

FIG. 1 is a schematic sectional view illustrating an exemplary stereo picture display apparatus of the present invention. The stereo picture display apparatus has a pair of a viewer-side polarizing film 16 and a backlight-side polarizing film 18, a picture displaying panel 1 disposed between the polarizing films, and a patterned retardation plate 20, and has a backlight 30 outside the backlight-side polarizing film 18. The patterned retardation plate 20 is disposed on the surface adjacent to a viewer of the displaying panel and segments a picture into polarized pictures (for example, circularly polarized pictures) for right and left eyes. The viewer views the polarized pictures through polarizing plates, such as polarizing glasses (for example, circularly polarizing glasses), and senses the polarized pictures as a stereo picture.

Each of the polarizing films 16 and 18 has protective films 24 on both sides. The viewer-side polarizing film 16 may be incorporated as a polarizing plate PTL1 having the protective films 24 bonded on both sides. The backlight-side polarizing film 18 may also be incorporated as a polarizing plate PTL2 having the protective films 24 bonded on both sides.

Although FIG. 1 is an exemplary schematic sectional view of the picture displaying panel that is a liquid crystal panel, the picture displaying panel 1 may be any other panel. The picture displaying panel 1 may be, for example, an organic EL displaying panel comprising an organic EL layer or a plasma displaying panel.

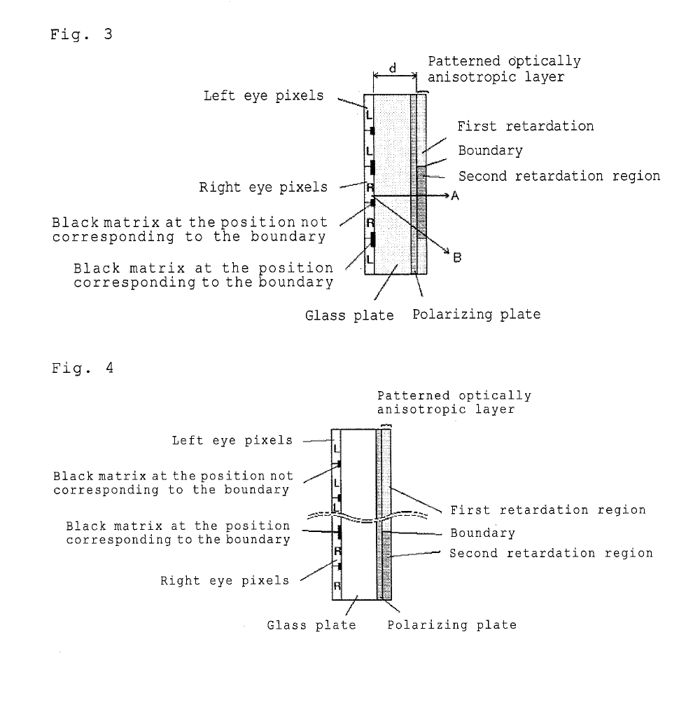

The patterned retardation plate 20 is a so-called FPR. FIG. 2 is a schematic sectional view illustrating an exemplary patterned retardation plate. The patterned retardation plate has a patterned optically anisotropic layer 12 having a first retardation region 14 and a second retardation region 15 on a support 13. The alignment of the optically anisotropic layer is controlled usually with an (optical) alignment film (not illustrated).

The patterned optically anisotropic layer 12 can be composed of one or more curable compositions each containing a liquid crystal compound as a principal component, preferably a liquid crystal compound having a polymerizable group. The patterned optically anisotropic layer 12 is preferably composed of a single curable composition. The patterned optically anisotropic layer 12 may have a monolayer or multilayer structure. The patterned optically anisotropic layer can be composed of one or two compositions each containing a liquid crystal compound as a principal component.

As illustrated in FIG. 2, the exemplary patterned optically anisotropic layer 12 is a patterned λ/4 layer where the slow axis a of the first retardation region 14 is orthogonal to the slow axis b of the second retardation region 15 and the in-plane retardation Re is λ/4. The combination of such a patterned optically anisotropic layer with a polarizing film enables light beams passing through the first and second retardation regions to be circularly polarized in opposite directions and generates circularly polarized pictures for right and left eyes, respectively.

The patterned λ/4 layer can be formed, for example, by forming a uniform alignment film on the surface of the support 13 to perform an alignment process in one direction, aligning the liquid crystal curable composition on the alignment-processed surface, and fixing the intended alignment state. In one of the first and second retardation regions 14 and 15, the liquid crystal is vertically aligned orthogonal to the direction of the orientation controlled process (for example, a rubbing direction), i.e., undergoes an orthogonal and vertical alignment. In the other, the liquid crystal is vertically aligned parallel to the direction of the orientation controlled process (for example, a rubbing direction), i.e., undergoes a parallel and vertical alignment. These states can be fixed to form the retardation regions.

A boundary is a region that is isotropic or has a retardation different from those of the first and second retardation regions 14 and 15. Although a smaller line width of the boundary is preferred, a usual line width is 3 to 20 μm.

The patterned retardation plate according to the present invention is useful as a component of a 3-dimensional picture display apparatus, in particular, a passive 3-dimensional picture display apparatus. In this configuration, respective polarized pictures passing through the first and second retardation regions are sensed as pictures for right and left eyes, for example, through polarizing glasses. To prevent imbalance between the right and left pictures, the first and second retardation regions preferably have the same shape and are preferably disposed uniformly and symmetrically.

In the present invention, the patterned optically anisotropic layer may have any configuration other than that illustrated in FIG. 2. In the display pixel region, one of the first and second retardation regions may have an in-plane retardation equal to λ/4 while the other may have an in-plane retardation equal to λ/4. Alternatively, one of the first and second retardation regions 14 and 15 may have an in-plane retardation equal to λ/2 while the other may have an in-plane retardation equal to 0.

The in-plane slow axes of patterns of the first and second retardation regions can be adjusted in mutually different directions, for example, mutually orthogonal directions using a patterned alignment film. The patterned alignment film may be any of a photo alignment film involving a patterning alignment film that can be formed through mask exposure, a rubbing alignment film involving a patterning alignment film that can be formed through mask-rubbing, and a film formed by patterning different types of alignment films (for example, a material having alignment orthogonal or parallel to rubbing) through printing, for example. When the respective in-plane slow axes of the first and second retardation regions are orthogonal to each other, the in-plane slow axes in the boundary are preferably directed at a substantially intermediate value of the in-plane slow axis directions of the first and second retardation regions, i.e., approximately 45°.

The patterned retardation plate according to the present invention may have any configuration other than the simplified embodiment illustrated in FIGS. 1 and 2 and may comprise other components. For example, the patterned optically anisotropic layer formed with an alignment film as described above may include an alignment film between the support and the patterned optically anisotropic layer. The patterned retardation plate according to the present invention may also include, for example, a forward scattering layer, a primer layer, an antistatic layer, or an undercoat layer in addition to (or instead of) a hardcoat layer, an antirefrection layer, a low reflection layer, or an antiglare layer.

The displaying panel 1 provided as a liquid crystal panel comprises a liquid crystal cell having a pair of substrates 1A and 1B and a liquid crystal layer 10 comprising a nematic liquid crystal material disposed between these substrates. Rubbing alignment films (not illustrated) are disposed on the inner surfaces of the substrates 1A and 1B and controls the alignment of nematic liquid crystals in the respective rubbing directions to cause twisted alignment. Electrode layers (not illustrated) are provided on the inner surfaces of the substrates 1A and 1B, and the twisted alignment of the nematic liquid crystals is relaxed during application of a voltage to cause the liquid crystal to align vertical to the substrate faces. The liquid crystal cell LC may comprise any other component, such as a color filter.

The liquid crystal cell may have a configuration of a usual liquid crystal cell. The liquid crystal cell may also be driven in any of various modes, such as twisted nematic (TN), super twisted nematic (STN), vertical alignment (VA), in-plane switching (IPS), and an optically compensated bend (OCB) cell.

The picture displaying panel may have any size and preferably has a size of 3.5 to 55 inches. The present invention likely provides higher advantageous effects for a size of 3.5 to 55 inches in particular.

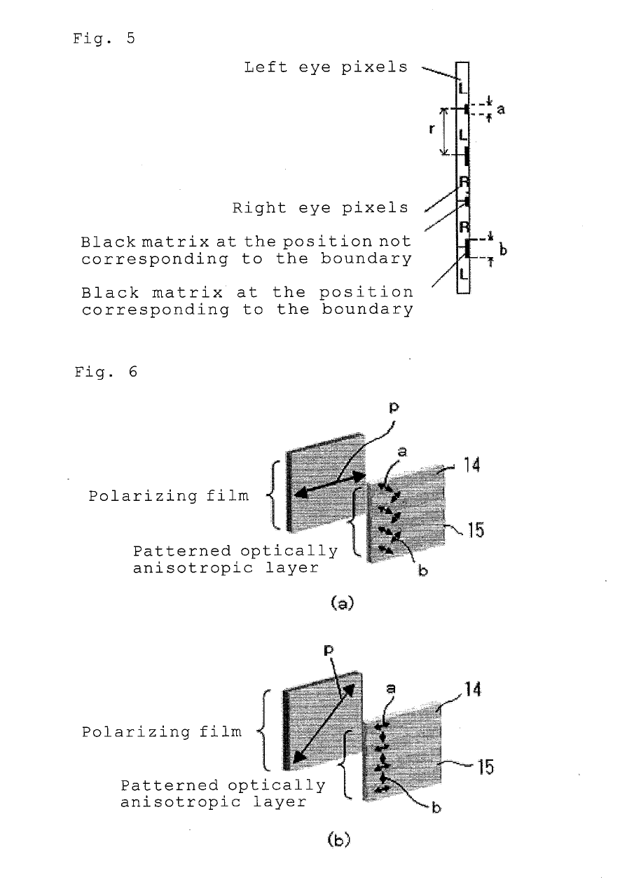

An exemplary displaying panel illustrated in FIG. 3 has at least left eye pixels L corresponding to a left eye picture, right eye pixels R corresponding to a right eye picture, and black matrix disposed between the pixels on its viewer side. On the viewer side of the displaying panel, glass, the polarizing plate, and the patterned retardation plate 20 are laminated in this order. Although FIG. 3 illustrates the case of n equal to 2, n may be 3 or more as illustrated in FIG. 4.

The n left eye pixels L and the n right eye pixels R are alternately disposed in the vertical direction of the stereo picture display apparatus. The parameter n is an integer equal to or more than 2, is preferably 2 to 8, and is more preferably 2. The vertical resolution is preferably 720 or more pixels, more preferably 1080 or more pixels, still more preferably 2160 or more pixels. The vertical resolution has no specific upper limit, but is usually 4320 or less pixels.

The pitch width of the first and second retardation regions 14 and 15 is n times the width of one pixel of the picture displaying panel. The first retardation region 14 is disposed corresponding to the left eye pixels L or the left eye right eye pixels R. The second retardation region 15 is disposed corresponding to the other pixels not corresponding to the first retardation region 14. In FIG. 2, the first and second retardation regions 14 and 15 correspond to the left and right eye pixels L and R, respectively. It should be appreciated that the first and second retardation regions may also correspond to the right and left eye pixels, respectively.

Components, such as the polarizing plate 16 and the glass are disposed between the picture displaying panel 1 and the patterned retardation plate 20. A shorter distance between each pixel of the picture displaying panel 1 and the first or second retardation region is more preferred since the cross talk can be more reduced. The distance d between each pixel and the first or second retardation region is preferably 800 μm or less, more preferably 600 μm or less, still more preferably 350 μm or less. The distance d has no specific lower limit, but is usually 50 μm or more. The thickness of the glass is preferably 700 μm or less, more preferably 500 μm or less, still more preferably 250 μm or less.

The black matrix is disposed between the pixels. More specifically, the black matrix is disposed between the left eye pixels, between the right eye pixels, and between the right and left eye pixels. The black matrix has a larger width between the right and left eye pixels, i.e., at a position corresponding to the boundary than that at a position not corresponding to the boundary (between the left eye pixels or between right eye pixels). The black matrix can have a larger width at the position corresponding to the boundary to therefore reduce the vertical cross talk. The position corresponding to the boundary refers to such a position in the black matrix that the boundary is located on a vertical line extended from the position along the direction toward the patterned retardation plate. The position not corresponding to the boundary refers to such a position in the black matrix that the boundary is not located on a vertical line extended from the position along the direction toward the patterned retardation plate.

Pixel light beams emitting from the left and right eye pixels L and R enter the first and second retardation regions and are segmented into polarized pictures for left and right eyes in the first and second retardation regions, respectively. In the present invention, the left eye pixels and the right eye pixels are alternately disposed at intervals of an integer of 2 or more, the pitch width of the first and second retardation regions 14 and 15 is n times the width of one pixel, and the black matrices disposed at a position corresponding to the boundary have a larger width than a width of the black matrices disposed at a position not corresponding to the boundary. This configuration enables, for example, not only a straight incident light beam indicated by the arrow A in FIG. 3 but also an incident light beam causing cross talk in traditional techniques and indicated by the arrow B in FIG. 7 (i.e., a slantwise incident light beam indicated by the arrow A in FIG. 3 in the present invention) to be segmented into polarized pictures for left and right eyes in the first and second retardation regions 14 and 15 without cross talk.

The parameter “n” in the n pixels disposed alternately is the same as the parameter “n” in the pitch width of the first and second retardation regions 14 and 15 being n times the width of one pixel and is an integer equal to or more than 2.

The widths a of the black matrix at positions not corresponding to the boundaries and the widths r of the right and left eye pixels satisfy preferably a ≦0.25×r, more preferably a ≦0.1×r, still more preferably a ≧0.05×r. These conditions can prevent a decrease in an aperture ratio.

More specifically, a is preferably 60 μm or less, more preferably 30 μm or less, still more preferably 15 μm or less. More specifically, r is preferably 1000 μm or less, more preferably 500 μm or less, still more preferably 150 μm or less.

As exemplarily illustrated in FIGS. 3 and 5, the parameter a refers to the width of the black matrix at a position not corresponding to the boundary, the width being measured in the vertical direction of the stereo picture display apparatus. As exemplarily illustrated in FIGS. 3 and 5, the parameter r refers to the width of the right or left eye pixel, the width being measured in the vertical direction of the stereo picture display apparatus.

The widths b of the black matrix at positions corresponding to the boundaries and the widths r of the right and left eye pixels satisfy preferably b≦r, more preferably b≦0.6×r, still more preferably b≦0.4×r. These conditions can prevent a decrease in an aperture ratio.

More specifically, b is preferably 500 μm or less, more preferably 300 μm or less, still more preferably 150 μm or less.

As exemplarily illustrated in FIGS. 3 and 5, the parameter b refers to the width of the black matrix at a position corresponding to the boundary measured in the vertical direction of the stereo picture display apparatus.

The widths a of the black matrix at positions not corresponding to the boundaries and the widths b of the black matrix at positions corresponding to the boundaries satisfy preferably 1.5≦b/a≦10, more preferably 2≦b/a≦8, still more preferably 3≦b/a≦5. These conditions can reduce the vertical cross talk and can also prevent a decrease in the aperture ratio.

The widths b of the black matrix at positions corresponding to the boundaries and the distance d between each pixel and the first or second retardation region satisfy preferably b≧0.10×d, more preferably b≧0.14×d, still more preferably b≧0.2×d. These conditions can reduce the vertical cross talk.

The polarizing film 16 is disposed to have a transmission axis orthogonal to that of the polarizing film 18. For example, the transmission axes of the polarizing films 16 and 18 are parallel to the rubbing axes of the substrates 1A and 1B, respectively.

The polarizing films 16 and 18 may be usual linearly polarizing films. These polarizing films may be stretched films or may be a layer formed through a coating process. The former or stretched film is, for example, formed by dyeing a stretched polyvinyl alcohol film with iodine or a dichroic dye. The latter or coating layer is, for example, a coating layer having a composition comprising a dichroic liquid crystal pigment and fixed to an intended alignment state.

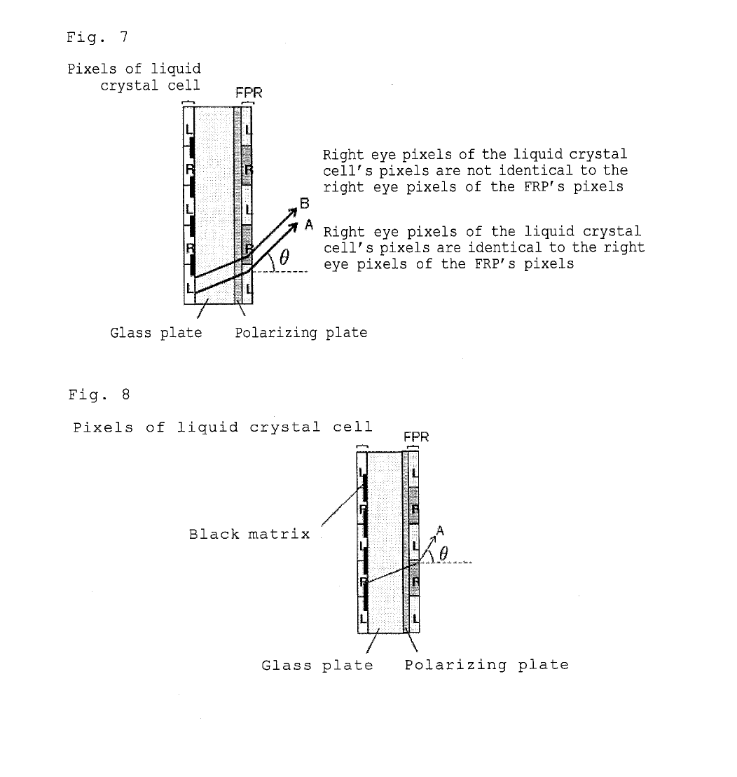

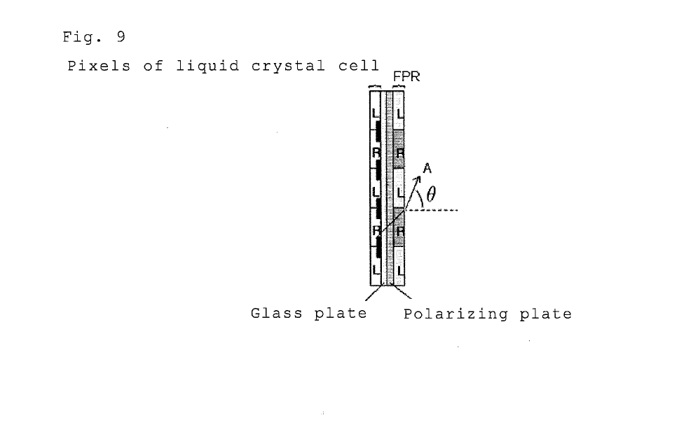

With reference to FIG. 6, an exemplary polarizing film 16 is disposed such that the in-plane slow axes a and b of the first and second retardation regions 14 and 15 cross the transmission axis p of the polarizing film at ±45°. The embodiments in the specification do not require an angle of strictly ±45°. In one of the first and second retardation regions 14 and 15, the angle is preferably 40 to 50°. In the other, the angle is preferably −40 to −50°. This configuration can segment a picture into circularly polarized pictures for right and left eyes. A λ/2 plate may additionally be laminated to enlarge the viewing angle.

No other layer or only an optically isotropic layer (for example, an adhesive layer) is preferably disposed between the patterned optically anisotropic layer 12 and the polarizing film 16.

The protective films 24 are disposed on both sides of each of the polarizing films 16 and 18. The protective film 24 may be selected from various polymeric films, such as a cellulose acylate film and a film comprising an acrylic polymer or a cyclic olefin resin as a principal component, which are widely used as protective films for polarizing plates. Alternatively, the protective film 24 may be replaced with a retardation film for compensation of the viewing angle or may be omitted. The in-plane slow axis of the retardation film is disposed preferably parallel or orthogonal, more preferably parallel to the rubbing direction provided on the inner surface of the substrate 1A or 1B. The retardation film may be an optically biaxial film and may include a support and an optically anisotropic layer composed of a cured rod or discotic liquid crystal compound.

The present invention also relates to a stereo picture display system that at least includes a stereo picture display apparatus and polarizing plates disposed on the viewer side of this stereo picture display apparatus, for allowing a viewer to view a stereo picture through these polarizing plates. The polarizing plates disposed on the outer viewer side of this stereo picture display apparatus are, for example, polarizing glasses worn by the viewer. The viewer observes polarized pictures for right and left eyes displayed on the stereo picture display apparatus through circularly or linearly polarizing glasses, as a stereo picture.

Several components used in the patterned retardation plate according to the present invention will be described below in detail.

### Liquid Crystal Cell:

The liquid crystal cell used in the stereo picture display apparatus and the stereo picture display system according to the present invention is preferably operational in a VA, OCB, IPS, or TN mode, but may be operational in any other mode.

In the TN mode liquid crystal cell, rod liquid crystal molecules have substantially horizontal alignment and twisted alignment at 60 to 120° during application of no voltage. TN mode liquid crystal cells are most frequently used in color TFT liquid crystal displays and are described in many literatures.

In the VA mode liquid crystal cell, rod liquid crystal molecules are substantially vertically aligned during application of no voltage. VA mode liquid crystal cells include (1) a narrowly-defined VA mode liquid crystal cell in which rod liquid crystal molecules are substantially vertically aligned during application of no voltage and substantially horizontally aligned during application of a voltage (as in Japanese Unexamined Patent Application Publication No. 2-176625), (2) a multi-domain VA mode (MVA mode) liquid crystal cell for enhancement of a viewing angle (as in SID97, Digest of Tech. Papers (Preprints), vol. 28, p. 845, 1997), (3) an n-ASM mode liquid crystal cell in which rod liquid crystal molecules are substantially vertically aligned during application of no voltage and twisted multi-domain alignment during application of a voltage (as in the preprint in the Nippon Liquid Crystal Discussion Meeting, pp. 58-59, 1998), and (4) a SURVIVAL mode liquid crystal cell (as announced in LCD International 98). Patterned vertical alignment (PVA), optical alignment, and polymer-sustained alignment (PSA) are also applicable. These modes are described in Japanese Unexamined Patent Application Publications Nos. 2006-215326 and 2008-538819 in detail.

In the IPS mode liquid crystal cell, rod liquid crystal molecules are aligned substantially parallel to a substrate and have in-plane response to application of an electric field parallel to the substrate face. In the IPS mode liquid crystal cell, application of no electric field causes a black display state, and vertically paired polarizing plates have mutually orthogonal absorption axes. Methods for reducing slantwise light leakage in a black display state with an optically compensating sheet to enlarge a viewing angle are disclosed, for example, in Japanese Unexamined Patent Application Publications Nos. 10-54982, 11-202323, 9-292522, 11-133408, 11-305217, and 10-307291.

Right and left eye pixels may be formed by known various techniques. For example, an intended black matrix and R, G, and B pixel patterns may be formed on a glass substrate with a photomask and photoresist. Alternatively, ink compositions (R, G, and B pixel coloring inks) may be ejected from an ink jet printer onto regions (recessions surrounded by projections) partitioned by thinner black matrix elements each having a predetermined width and a thicker black matrix element having a larger width than the thinner black matrix for every n thinner matrix elements until the compositions reaches intended densities. This process may also form color filters having R, G, and B pattern. After coloring a picture, the pixels and the black matrix may be baked to be cured completely.

### Black Matrix

The stereo picture display apparatus according to the present invention has a black matrix disposed between the pixels. Black stripes are formed, for example, of a sputtered metallic (for example, chromium) film or a light shielding photosensitive composition containing a photosensitive resin and a black coloring agent. The black coloring agent is, for example, carbon black, titanium carbon, iron oxide, titanium oxide, or graphite. Among these, carbon black is most preferred.

### Patterned Optically Anisotropic Layer:

The patterned optically anisotropic layer according to the present invention comprises a first retardation region and a second retardation region, at least one of the in-plane slow axis direction and the in-plane retardation of which differs from each other, in which the first and second retardation regions are alternately disposed in the plane, and the boundaries are disposed between the first and second retardation regions. The pitch width of the first and second retardation regions is n times the width of one pixel. In an exemplary optically anisotropic layer, the first and second retardation regions each have an Re value equal to approximately λ/4, a mutually orthogonal in-plane slow axes, and a pitch width n times the width of one pixel. Such a patterned optically anisotropic layer is formed in various manners. In the present invention, the patterned optically anisotropic layer is preferably formed through polymerization and then fixation of a horizontally aligned rod liquid crystal and a vertically aligned discotic liquid crystal that each have a polymerizable group.

The patterned optically anisotropic layer may have Re equal to approximately λ/4 as a one layer. In this case, Re(550) is preferably λ/4±30 nm, more preferably 110 to 165 nm, still more preferably 120 to 150 nm, further still more preferably 125 to 145 nm. Throughout the specification, the in-plane retardation Re equal to λ/4 and λ/2 refers to a value in a range of approximately ±30 nm from ¼ and ½ of a wavelength λ unless otherwise stated. Commercially available supports usually have a positive Rth value. The patterned optically anisotropic layer formed on a support having a positive Rth value preferably has a negative Rth(550) value, which is more preferably −80 to −50 nm, still more preferably −75 to −60 nm.

Liquid crystal compounds are usually classified into rod and discotic types based on their shapes. Each type is further classified into low-molecular and high-molecular types. The high-molecular type usually refers to a molecule having a degree of polymerization of 100 or more (Masao Doi, Polymer physics and phase transition dynamics, p. 2, Iwanami Shoten, Publishers, 1992). Although any liquid crystal compound is usable in the present invention, rod or discotic liquid crystal compounds are preferred. Two or more rod liquid crystal compounds, two or more discotic liquid crystal compounds, or mixtures of rod and discotic liquid crystal compounds may also be used. In order to reduce a variation in temperature or humidity, the patterned optically anisotropic layer is more preferably formed of rod or discotic liquid crystal compounds having reactive groups, and at least one of the liquid crystal compounds still more preferably has two or more reactive groups in one liquid crystal molecule. Two or more liquid crystal compounds may also be used in the form of a mixture. In this case, at least one of the compounds preferably has two or more reactive groups.

Preferred rod liquid crystal compounds are described, for example, in Japanese Unexamined Patent Application Publications Nos. 11-513019 and 2007-279688. Preferred discotic liquid crystal compounds are described, for example, in Japanese Unexamined Patent Application Publications Nos. 2007-108732 and 2010-244038. Any other liquid crystal compound may also be used.

The liquid crystal compound preferably has two or more reactive groups polymerizable under different polymerization conditions. In such a case, a limited type or types of reactive groups among the overall reactive groups can be polymerized under selected polymerization conditions to prepare a retardation layer containing polymer having remaining reactive groups. Conditions for polymerization include use of ionizing radiation with different wavelengths for polymerization and use of different polymerization mechanisms. Preferred is a combination of radically reactive groups and cationic reactive groups which can be independently controlled by different types of initiators. A particularly preferred combination is an acryl and/or radically reactive methacrylic groups and a vinyl ether, oxetane, or cationically reactive epoxy group because the reactivity of the combination can be readily controlled.

The optically anisotropic layer can be prepared by several embodiments using an alignment film without limitation.

The first embodiment involves cancelling some factors from a plurality of factors affecting the alignment control of the liquid crystal by extrinsic stimulation such as annealing so that an intended factor dominates the alignment control. For example, the liquid crystal is aligned into a predetermined state by a compound effect of the alignment control by an alignment film and the alignment control by an alignment controlling agent contained in the liquid crystal compound, and the alignment is fixed to form one of the retardation region; then one (for example, the alignment control by an alignment controlling agent) of the alignment controls is cancelled by extrinsic stimulation such as annealing so that the other alignment control by the alignment film is dominant, and the alignment is fixed to form the other retardation region. For example, specific pyridinium compounds and imidazolium compounds having hydrophilic pyridinium groups and hydrophilic imidazolium groups, respectively, can be eccentrically located on the hydrophilic poly(vinyl alcohol) alignment film. If the pyridinium groups are replaced with amino groups, which function as an acceptor of a hydrogen atom, a high density of pyridinium groups are concentrated onto the surface of the alignment film due to intermolecular hydrogen bonds between the amino groups and poly(vinyl alcohol) and the pyridinium derivative molecules are aligned orthogonal to the main chains of the poly (vinyl alcohol) molecules by the hydrogen bonds, facilitating orthogonal alignment of liquid crystal to the rubbing direction. The pyridinium derivative having a plurality of intramolecular aryl rings induces strong intermolecular π-π interaction with the liquid crystal compound, in particular, discotic liquid crystal compound and thus facilitates orthogonal alignment of the discotic liquid crystal molecules in the vicinity of the interface of the alignment film. In particular, if a hydrophobic aryl ring is bonded to the hydrophilic pyridinium group, the hydrophobic group can induce orthogonal alignment. If the system however is heated to a predetermined temperature or more, the hydrogen bonds are broken and the density of the pyridinium compound decreases on the surface of the alignment film. As a result, the liquid crystal molecules are aligned by the restraining force of the rubbing alignment film itself into a parallel alignment state. The details of this process are described in Japanese Unexamined Patent Application Publication No. 2012-008170, the teachings of which are incorporated herein by reference.

The second embodiment involves use of patterned alignment films. In this embodiment, patterned alignment films having different alignment controlling characteristics are formed and then a liquid crystal compound is disposed to be aligned thereon. The liquid crystal is aligned into different states as a result of regulations by alignment controlling characteristics of individual patterned alignment films. After these aligned states are fixed, the patterns of the first and second retardation areas are formed corresponding to the patterns of the alignment films. The patterned alignment film can be formed by printing, mask rubbing to a rubbing alignment film, or mask exposure to the photoalignment film, for example. Alternatively, the alignment film can be formed through formation of a uniform alignment film and printing a predetermined pattern on the alignment film with an additive affecting the alignment controlling characteristics such as an onium salt. Preferred is a printing process, which does not require a lot of equipment and can readily produce alignment films. The details of this process are described in Japanese Unexamined Patent Application Publication No. 2012-032661, the teachings of which are incorporated herein by reference.

The first embodiment may be combined with the second embodiment. For example, a photoacid-generating agent is used. In this case, an alignment film containing a photoacid-generating agent is exposed through a mask pattern to form regions containing acidic compounds generated by photodegradation of the photoacid-generating agent and other regions not containing acidic compounds. In the unexposed regions, which contain the photoacid-generating agent almost remaining undecomposed, an interaction between the material of the alignment film, liquid crystal, and optional alignment controlling agent dominates the state of alignment and thus aligns liquid crystal molecules such that the slow axis is orthogonal to the rubbing direction. After photoacid generating agent is generated by photoexposure of the alignment film, such an interaction is no longer dominant, and the direction of rubbing on the alignment film dominates the state of alignment. As a result, the liquid crystal molecules are aligned such that its slow axis is parallel to the direction of rubbing. Water-soluble photoacid-generating agents are preferably added to the alignment film. Examples of usable photoacid-generating agent include compounds disclosed in Prog. Polym. Sci., vol. 23, p. 1485 (1998). Particularly preferred photoacid-generating agents are pyridinium salts, iodonium salts, and sulfonium salts. The details of this process are described in Japanese Unexamined Patent Application Publication No. 2012-150428, which claims priority to Japanese Patent Application No. 2010-289360, the teachings of which are incorporated herein by reference.

Third embodiment involves use of a discotic liquid crystal compound having polymerizable groups having different polymerization characteristics, for example, an oxetanyl group and a polymerizable ethylenic unsaturated group. In this embodiment, the discotic liquid crystal compound is aligned in a predetermined state, and the compound is exposed to light under conditions causing polymerization of only one of the polymerizable group, to form an optically anisotropic preliminary layer. The liquid crystal compound is exposed to light through a mask under conditions causing polymerization of the other polymerizable group (for example, in the presence of a polymerization initiator for the other polymerizable group). The alignment in the exposed regions are completely fixed to form a retardation regions having a predetermined Re. In the unexposed regions, the reaction of one of the reactive groups proceeds, but the other reactive group still remains unreacted. Heating the compound to a temperature that enables the other reactive group to react above an isotropic phase temperature fixes the unexposed regions to the state of an isotropic phase, resulting in Re=0 nm.

Any material may be used as a support (support film) in the present invention. Preferred are polymer films having a low retardation value, more specifically, films having an absolute in-plane retardation of about 10 nm or less. Also in an embodiment where a protective film is provided between a polarizing film and a patterned retardation film, the protective film is preferably a polymer film with a low retardation value. The specific range of the retardation is defined as above.

Examples of the materials usable for the support in the present invention include polycarbonate polymers, polyester polymers such as poly(ethylene terephthalate) and poly(ethylene naphthalate), acrylic polymers such as poly(methyl methacrylate), and styrene polymers such as polystyrene and acrylonitrile-styrene copolymers (AS resins). Further examples include polyolefin polymers such as polyethylene, polypropylene, polyolefin copolymers such as ethylene-propylene copolymers, poly(vinyl chloride) polymers, amide polymers such as nylon and aromatic polyamides, imide polymers, sulfone polymers, polyether sulfone polymers, polyether ether ketone polymers, polyphenylene sulfide polymers, vinylidene chloride polymers, vinyl alcohol polymers, vinyl butyral polymers, arylate polymers, polyoxymethylene polymers, epoxy polymers, and mixtures thereof. The polymer film of the present invention may be a cured layer made of a uv-curable or heat-curable resin, for example, an acrylic, urethane, acrylic urethane, epoxy, or silicone resin.

Examples of preferred material for the film include thermoplastic norbornene resins, such as Zeonex, Zeonor available from Zeon Corporation and Arton available from JSR.

Further examples of preferred material for the film include cellulosic polymers (hereinafter referred to as cellulose acylate), such as triacetyl cellulose, which has been used as transparent protective films of polarizers.

The patterned optically anisotropic layer formed in this way may have any thickness. The thickness is preferably 0.1 to 10 μm, more preferably 0.5 to 5 μm.

### Polarizing Film:

The polarizing film may be a usual polarizing film. The polarizing film may be, for example, of a polyvinyl alcohol film dyed with iodine or a dichroic dye.

### Adhesive Layer:

An adhesive layer may be disposed between the optically anisotropic layer and the polarizing film. The adhesive layer used in lamination of the optically anisotropic layer and the polarizing film may be composed, for example, of a substance having a tan δ value (G″/G′ ratio) of 0.001 to 1.5, where G′ and G″ are measured with a dynamic viscoelastometer. Such a substance is, for example, an adhesive agent or a readily creepable substance. Any adhesive agent, such as a polyvinyl alcohol adhesive agent, can be used.

### Polarizing Plates for Stereo Picture Display System

In the stereo picture display system according to the present invention, a viewer senses a 3-dimensional picture, i.e., a stereo picture through polarizing plates. The polarizing plates are, for example, polarizing glasses. Circularly polarizing glasses are used when circularly polarized pictures for right and left eyes are formed through the retardation plate. Linearly polarizing glasses are used when linearly polarized pictures are formed. It is preferred that right eye picture light emitting from one of the first and second retardation regions in the optically anisotropic layer be transmitted through a right glass but shielded by a left glass while left eye picture light emitting from the other be transmitted through the left glass but shielded by the right glass.

The polarizing glasses each comprise a retardation functional layer and a linear polarizer to serve as polarizing glasses. Any other component having a function identical to the linear polarizer can also be used.

A specific configuration of the stereo picture display system according to the present invention will be described together with the polarizing glasses. In the retardation plate, the first and second retardation regions each having different polarization converting functions are provided on alternately disposed first lines and second lines (for example, odd numbered horizontal or vertical lines and even numbered horizontal or vertical lines), respectively, on the picture displaying panel. In order to display circularly polarized pictures, the first and second retardation regions each preferably have a retardation of λ/4 and more preferably have mutually orthogonal slow axes.

When a right eye picture is displayed on the odd numbered lines of the picture displaying panel by circular polarization at a retardation value of λ/4 in the first and second retardation regions in which the slow axis of the retardation regions on the odd numbered lines is aligned at 45°, it is preferred that the right and left polarizing glasses each be formed of a λ/4 plate, and the λ/4 plate in the right polarizing glass specifically have a slow axis fixed to substantially 45°. Under such conditions, when a left eye picture is displayed on the even numbered lines of the picture displaying panel in which the slow axis of the retardation regions on the even numbered lines is aligned at 135°, the left glass of the polarizing glasses specifically has a slow axis fixed to substantially 135°.

In order to reconstruct the original polarization state through the polarizing glasses from circularly polarized picture light from the patterned retardation film, the angle of the slow axis in the right glass in the above-described case is preferably fixed to 45° from the horizontal direction as exactly as possible. In addition, the angle of the slow axis in the left glass is preferably fixed to 135° (or −45°) from the horizontal direction as exactly as possible.

If the picture displaying panel is, for example, a liquid crystal displaying panel, the front polarizing plate of the liquid crystal displaying panel usually has a horizontal absorption axis. In this case, the absorption axis of the linear polarizer of the polarizing glass is preferably orthogonal to the absorption axis of the front polarizing plate, and is more preferably vertical.

In order to achieve efficient polarization conversion, the direction of the absorption axis of the front polarizing plate in the liquid crystal displaying panel preferably crosses each of the slow axes of the retardation regions on the odd and even numbered lines of the patterned retardation film at 45°.

Preferred layouts of such polarizing glasses, a patterned retardation film, and a liquid crystal display are disclosed, for example, in Japanese Unexamined Patent Application Publication No. 2004-170693.

Examples of the polarizing glasses include polarizing glasses disclosed in Japanese Unexamined Patent Application Publication No. 2004-170693 and commercial items, such as accessories of ZM-M220W produced by ZALMAN Tech Co., Ltd. and 55LW5700 produced by LG Electronics Incorporated.

### EXAMPLES

The present invention will be described on the basis of examples below in more detail. Materials, amounts of used materials, contents of materials, details of treatments, procedures for treatments, and other parameters described in the following examples may be appropriately modified without departing from the scope and spirit of the present invention. The scope of the present invention should not be limited to the following examples.

### [Preparation of Patterned Retardation Plate]

### <<Alkali Saponification Treatment>>

An antiglare film (CV-LU3 produced by Fujifilm Corporation) having a cellulose acetate support was prepared and treated through a dielectric heating roll at 60° C. to heat the film surface to 40° C. A free surface (not having an antirefrection layer) of the CV-LU3 film was then coated with an alkaline solution having the following composition with a bar coater into a coating density of 14 ml/m². The resultant film was heated to 110° C. and was conveyed for 10 seconds under a steam far-infrared heater produced by Noritake Co., Limited. Similarly, pure water of 3 ml/m² was then applied with a bar coater. Water washing with a fountain coater and throating with an air knife were then repeated three times. The resultant film was then dried for 10 seconds through a drying zone at 70° C. to prepare a cellulose acetate transparent support subject after alkali saponification treatment.

The composition of the alkaline solution (parts by weight)

| | |
|---|---|
| Potassium hydroxide | 4.7 parts by weight |
| Water | 15.8 parts by weight |
| Isopropanol | 63.7 parts by weight |
| Surfactant | |
| SF-1: C₁₄H₂₉O(CH₂CH₂O)₂₀H | 1.0 parts by weight |
| Propylene glycol | 14.8 parts by weight |

<Preparation of Transparent Support with Rubbing Alignment Film>

The saponified surface of the prepared support was continuously coated with a rubbing alignment film coating liquid having the following composition using a wire bar applicator #8. The resultant support was dried under hot air at 60° C. for 60 seconds and then hot air at 100° C. for 120 seconds to form an alignment film. A stripe mask having a horizontal stripe width of 485 μm in each of transmittable portions and shielding portions was then disposed on the rubbing alignment film and was exposed to ultraviolet light with an air-cooling metal halide lamp (produced by EYE GRAPHICS Co., Ltd.) with an illuminance of 2.5 mW/cm² in a UV-C region in air at a room temperature for 4 seconds. This process decomposed a photoacid-generating agent into acidic compounds and thereby formed an alignment layer for the first retardation region. One reciprocating rubbing treatment was then performed at 500 rpm at 45° from the stripe of the stripe mask to prepare a transparent support with a rubbing alignment film. The alignment film had a thickness of 0.5 μm.

The composition of the rubbing alignment film coating
liquid

| | | |
|---|---|---|
| Polymer material for the alignment film | 3.9 | parts by |
| (Polyvinyl alcohol (PVA103 produced by KURARAY Co., | | weight |
| Ltd.)) | | |
| Photoacid-generating agent (S-2) | 0.1 | parts by |
| | | weight |
| Methanol | 36 | parts by |
| | | weight |
| Water | 60 | parts by |
| | | weight |

[Chemical Formula 1]
Photoacid-generating agent S-2

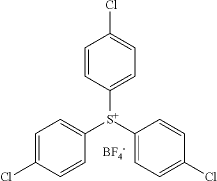

### <Preparation of Patterned Optically Anisotropic Layer D>

The following optically anisotropic layer coating liquid was applied with a bar coater. The resultant film was then heated and aged at a layer surface temperature of 110° C. for two minutes, cooled down to 80° C., exposed to ultraviolet light with an air-cooling metal halide lamp (produced by EYE GRAPHICS Co., Ltd.) of 20 mW/cm² in air for 20 seconds, and fixed to an alignment state to form a patterned optically anisotropic layer D. The discotic liquid crystal was vertically aligned to have a slow axis parallel to the rubbing direction in the exposed mask portions (first retardation regions) and a slow axis orthogonal to the rubbing direction in the unexposed portions (second retardation regions). The optically anisotropic layer had a thickness of 1.6 μm. The boundary had a width of 6 to 10 μm, which varied periodically.

Composition of optically anisotropic layer coating liquid

| | | |
|---|---|---|
| Discotic liquid crystal E-1 | 100 | parts by |
| | | weight |
| Alignment film interface aligning agent (II-1) | 1.0 | parts by |
| | | weight |
| Air interface aligning agent (P-1) | 0.3 | parts by |
| | | weight |
| Photopolymerization initiator | 3.0 | parts by |
| (Irgacure 907 produced by Ciba Japan K.K.) | | weight |
| Sensitizer (Kayacure-DETX produced by Nippon Kayaku Co., | 1.0 | parts by |
| Ltd.) | | weight |
| Ethylene oxide-modified trimethylolpropane triacrylate | 9.9 | parts by |
| (V#360 produced by OSAKA ORGANIC CHEMICAL INDUSTRY LTD.) | | weight |
| Methyl ethyl ketone | 400 | parts by |
| | | weight |

[Chemical Formula 2]
Discotic liquid crystal E-1 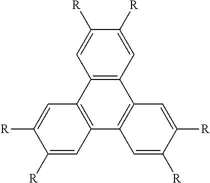 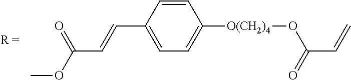
Alignment film interface aligning agent (II-1) 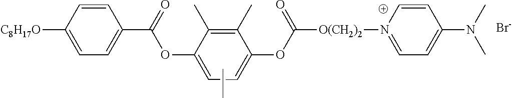
Air interface aligning agent (P-1)

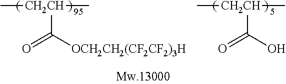

### (Preparation of Black Matrix)

A black matrix having an intended width was formed on the surface of a glass substrate through a transfer process using Transer produced by Fujifilm Corporation.

### (Preparation of Stereo Picture Liquid Crystal Display Apparatus)

### Examples 1 to 3

A viewer-side polarizing plate of a liquid crystal television set (42LD860 produced by LG Electronics Incorporated) was removed to form a black matrix having an intended width at positions corresponding to the boundaries on the viewer-side surface of the glass in the above-described manner. The removed polarizing plate was rebound, and then the patterned retardation plate prepared in the above-described manner was bonded to prepare each liquid crystal display apparatus illustrated in the following table.

### Examples 4 to 6

Liquid crystal display apparatuses illustrated in the following tables were prepared in the same manner as that described above except that liquid crystal television sets (47LEX8 produced by LG Electronics Incorporated) were used.

### Examples 7 to 9

Liquid crystal display apparatuses illustrated in the following table were prepared in the same manner as that described above except that smart phones (iPhone4 produced by Apple Inc.) were used.

### Comparative Example 1

A liquid crystal television set (32ZP2 produced by Toshiba Corporation) was used in Comparative Example 1.

### Comparative Example 2

A liquid crystal television set (42LW5700 produced by LG Electronics Incorporated) was used in Comparative Example 2.

### Comparative Example 3

A liquid crystal television set (47LW5700 produced by LG Electronics Incorporated) was used in Comparative Example 3.

### Comparative Example 4

A liquid crystal television set (55LW5700 produced by LG Electronics Incorporated) was used in Comparative Example 4.

### Comparative Example 5

Patterned retardation plate prepared in the above-described manner was bonded on the surface of a viewer-side polarizing plate of a liquid crystal television set (42LD860 produced by LG Electronics Incorporated) to prepare a liquid crystal display apparatus illustrated in the following table.

### Comparative Example 6

Patterned retardation plate prepared in the above-described manner was bonded on the surface of a viewer-side polarizing plate of a liquid crystal television set (47LEX8 produced by LG Electronics Incorporated) to prepare a liquid crystal display apparatus illustrated in the following table.

### Evaluation:

### (1) Vertical Cross Talk Viewing Angle

A stereo picture consisting of an entire white picture for the right eye and an entire black picture for the left eye was displayed on the prepared stereo display apparatus to measure the brightness in the vertical range of a polar angle of +80° to −80° with a brightness meter (BM-5A produced by TOPCON TECHNOHOUSE CORPORATION), the right glass of 3-dimensional glasses being attached to the lens of BM-5A. The left glass of the 3-dimensional glasses was similarly attached to the lens of BM-5A to measure the brightness in the vertical range of a polar angle of +80° to −80°. Cross talk was defined as a value obtained by dividing the brightness measured through the left glass of the 3-dimensional glasses by the brightness measured through the right glass. A viewing angle was defined as a polar angle range at a cross talk of 7% or less. Tables 1 to 3 illustrate the results of measurement.

### (2) Panel Aperture Ratio

The size of one pixel and the width of black matrix of the prepared stereo display apparatus were measured with a length meter (QV-ACCEL produced by Mitutoyo Corporation) to calculate the aperture ratio of the panel.

TABLE 1

| | Example1 | Example2 | Example3 | Example4 | Example5 |
|---|---|---|---|---|---|
| Screen size | 42 inch | 42 inch | 42 inch | 47 inch | 47 inch |
| Vertical resolution | 1080 | 1080 | 1080 | 1080 | 1080 |
| width of the one pixel(r)(μm) | 484 | 484 | 484 | 536 | 536 |
| n | 2 | 2 | 2 | 2 | 2 |
| Thickness of glass plate(μm) | 700 | 700 | 700 | 700 | 700 |
| Thickness of polarizing plate(except FPR)(μm) | 200 | 200 | 200 | 200 | 200 |
| Distance between the retardation region and | 900 | 900 | 900 | 900 | 900 |
| the pixel(d) | | | | | |
| Width of the black matrix overlapping with the | 100 | 200 | 400 | 100 | 200 |
| boundary(b)(μm) | | | | | |
| Width of the black matrix does not | 75 | 75 | 75 | 75 | 75 |
| overlapping with the boundary(a)(μm) | | | | | |
| 0.25 × r | 121 | 121 | 121 | 134 | 134 |
| 0.10 × d | 90 | 90 | 90 | 90 | 90 |
| Vertical Cross Talk Viewing Angle | 10° | 19° | 38° | 10° | 19° |
| Panel Aperture Ratio | 67% | 58% | 41% | 65% | 58% |

BM represents black matrix.

TABLE 2

| | Example | Example | Example | Example |
|---|---|---|---|---|
| | 6 | 7 | 8 | 9 |
| Screen size | 47 inch | 3.5 inch | 3.5 inch | 3.5 inch |
| Vertical resolution | 1080 | 960 | 960 | 960 |
| width of the one | 536 | 77 | 77 | 77 |
| pixel(r)(μm) | | | | |
| n | 2 | 2 | 2 | 2 |
| Thickness of glass | 700 | 250 | 250 | 250 |
| plate(μm) | | | | |
| Thickness of polarizing | 200 | 100 | 100 | 100 |
| plate(except FPR)(μm) | | | | |
| Distance between the | 900 | 350 | 350 | 350 |
| retardation region and the | | | | |
| pixel(d) | | | | |
| Width of the black matrix | 400 | 40 | 50 | 60 |
| overlapping with the | | | | |
| boundary(b)(μm) | | | | |
| Width of the black matrix | 75 | 19 | 19 | 19 |
| does not overlapping | | | | |
| with the boundary(a)(μm) | | | | |
| 0.25 × r | 134 | 19.25 | 19.25 | 19.25 |
| 0.10 × d | 90 | 35 | 35 | 35 |
| Viewing Angle | 38° | 10° | 12° | 15° |
| Panel Aperture Ratio | 43% | 47% | 42% | 37% |

BM represents black matrix.

TABLE 3

| | Comparative | Comparative | Comparative | Comparative | Comparative | Comparative |
|---|---|---|---|---|---|---|
| | Example 1 | Example 2 | Example 3 | Example 4 | Example 5 | Example 6 |
| Screen size | 32 inch | 42 inch | 47 inch | 55 inch | 42 inch | 47 inch |
| Vertical resolution | 1080 | 1080 | 1080 | 1080 | 1080 | 1080 |
| width of the one pixel (r) (μm) | 363 | 484 | 536 | 628 | 484 | 536 |
| n | 1 | 1 | 1 | 1 | 1 | 1 |
| Thickness of glass plate (μm) | 700 | 700 | 700 | 700 | 700 | 700 |
| Thickness of polarizing | 200 | 200 | 200 | 200 | 200 | 200 |
| plate (except FPR) (μm) | | | | | | |
| Distance between the | 900 | 900 | 900 | 900 | 900 | 900 |
| retardation region and the | | | | | | |
| pixel (d) | | | | | | |
| Width of the black matrix | 143 | 249 | 221 | 231 | 75 | 75 |
| overlapping with the | | | | | | |
| boundary (b) (μm) | | | | | | |
| Width of the black matrix does | — | — | — | — | — | — |
| not overlapping with the | | | | | | |
| boundary (a) (μm) | | | | | | |
| 0.25 × r | 90.75 | 121 | 134 | 157 | 121 | 134 |
| 0.10 × d | 90 | 90 | 90 | 90 | 90 | 90 |
| Viewing Angle | 14° | 24° | 21° | 22° | 7° | 7° |
| Panel Aperture Ratio | 50% | 40% | 49% | 54% | 69% | 67% |

BM represents black matrix

The tables show that the cross talk viewing angle and the aperture ratio can be improved by a configuration in which groups each composed of n left eye pixels and groups each composed of n right eye pixels are alternately disposed, the pitch width of the first and second retardation regions is n times the width of one pixel, and the black matrix have a larger width at a position corresponding to the boundary than that at a position not corresponding to the boundary.

### DESCRIPTION OF REFERENCE NUMERALS

1 picture displaying panel
1A, 1B substrates
10 liquid crystal layer
12 patterned optically anisotropic layer
13 support
14 first retardation region
15 second retardation region
16 viewer-side polarizing film
18 backlight-side polarizing film
20 patterned retardation plate
24 protective film
30 backlight

What is claimed is:

1. A stereo picture display apparatus comprising a picture displaying panel and a patterned retardation plate disposed on a viewer side of the picture displaying panel, wherein
the picture displaying panel comprises left eye pixels corresponding to a left eye picture, and right eye pixels corresponding to a right eye picture, and black matrices;
the left eye pixels and the right eye pixels alternatively being disposed at intervals of n pixels where n is an integer of 2 or more,
the black matrices being disposed between each of the pixels,
the patterned retardation plate comprises a support, and a patterned optically anisotropic layer disposed on the support;
the optically anisotropic layer having first retardation regions, second retardation regions, and boundaries, the first and second retardation regions being alternately disposed at a predetermined pitch width in stripe pattern,
the first and second retardation regions being different in at least one of an in-plane slow axis direction and a retardation from each other,
the boundary being disposed between the first retardation region and second retardation region;
the first retardation region is disposed so as to correspond to one of the right eye pixels and left eye pixels while the second retardation region is disposed so as to correspond to the other pixles;
the pitch width of the first and second retardation region is n times the width of the pixel in the picture displaying panel; and
the black matrices disposed at a position corresponding to the boundary have a larger width than a width of the black matrices not disposed at a position corresponding to the boundary.

2. The stereo picture display apparatus according to claim 1, which satisfies a ≦0.25×r, where a is a width of the black matrix at the position not corresponding to the boundary, and r is a width of the right or left eye pixel.

3. The stereo picture display apparatus according to claim 1, which satisfies b≧0.10×d, where b is a width of the black matrix at the position corresponding to the boundary, and d is a distance between the pixel and the first or second retardation region.

4. The stereo picture display apparatus according to claim 1, which satisfies b≦r, where b is a width of the black matrix at the position corresponding to the boundary, and r is a width of the right or left eye pixel.

5. The stereo picture display apparatus according to claim 1, wherein the stereo picture display apparatus has a vertical resolution of 720 or more pixels.

6. The stereo picture display apparatus according to claim 1, which satisfies 1.5≦b/a≦10 where a is a width of the black matrix at the position not corresponding to the boundary, and b is a width of the black matrix at the position corresponding to the boundary.

7. The stereo picture display apparatus according to claim 1, wherein the first and second retardation regions have mutually orthogonal in-plane slow axes and have an in-plane retardation of λ/4.

8. The stereo picture display apparatus according to claim 1, wherein n is 2.

9. The stereo picture display apparatus according to claim 1, wherein the support is a polymer film.

10. The stereo picture display apparatus according to claim 1, wherein the picture displaying panel is a liquid crystal displaying panel.

11. The stereo picture display apparatus according to claim 2, which satisfies b≧0.10×d, where b is a width of the black matrix at the position corresponding to the boundary, and d is a distance between the pixel and the first or second retardation region.

12. The stereo picture display apparatus according to claim 2, which satisfies b≦r, where b is a width of the black matrix at the position corresponding to the boundary, and r is a width of the right or left eye pixel.

13. The stereo picture display apparatus according to claim 2, wherein the stereo picture display apparatus has a vertical resolution of 720 or more pixels.

14. The stereo picture display apparatus according to claim 2, which satisfies 1.5≦b/a≦10 where a is a width of the black matrix at the position not corresponding to the boundary, and b is a width of the black matrix at the position corresponding to the boundary.

15. The stereo picture display apparatus according to claim 2, wherein the first and second retardation regions have mutually orthogonal in-plane slow axes and have an in-plane retardation of λ/4.

16. The stereo picture display apparatus according to claim 2, wherein n is 2.

17. The stereo picture display apparatus according to claim 3, which satisfies b≦r, where b is a width of the black matrix at the position corresponding to the boundary, and r is a width of the right or left eye pixel.

18. The stereo picture display apparatus according to claim 3, wherein the stereo picture display apparatus has a vertical resolution of 720 or more pixels.

19. The stereo picture display apparatus according to claim 3, which satisfies 1.5≦b/a≦10 where a is a width of the black matrix at the position not corresponding to the boundary, and b is a width of the black matrix at the position corresponding to the boundary.

20. A stereo picture display system allowing a viewer to view a stereo picture on the stereo picture display apparatus according to claim 1 through circularly polarizing plate glasses.
